(19) United States
(12) Patent Application Publication
(10) Pub. No.: US 2006/0048665 A1
(43) Pub. Date: Mar. 9, 2006

(54) Inflatable member projectile

(76) Inventor: Anthony David Kilvert, Dorset (GB)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/913,795

(22) Filed: Aug. 6, 2004

(30) Foreign Application Priority Data
Aug. 7, 2003 (GB) 0318500.6

(51) Int. Cl. B64D 1/04; F42B 22/00

(52) U.S. Cl. 102/406; 89/1.11

(57) ABSTRACT

An inflatable member projectile comprising: a projectile body having one end more buoyant than the other; an inflatable roll for vessel-immobilising; an inflation gas bottle at the less buoyant end of the body for inflating the inflatable roll and a cradle for supporting the roll in an orientation such that the inflatable roll unrolls in a generally pre-determined deployment direction, i.e. with the projectile floating with the less buoyant end down corresponding with their orientation. The cradle comprises a number of radiating channels, each locating one inflatable roll. Each roll has a serpentine portion in the bottom of its channel, for assisting in lifting the roll over a closed end of the channel. The cradle has a lifter for lifting the rolls up out of the cradle, actuated by the inflation gas.

### CROSS-REFERENCE TO RELATED APPLICATIONS

The present application claims priority under 35 USC § 119 to United Kingdom Patent Application No. 0318500.6 filed on Aug. 7, 2003.

### TECHNICAL FIELD

The present invention relates to an inflatable member projectile, particularly though not exclusively for use as a vessel immobiliser projectile.

### BACKGROUND OF THE INVENTION

It is known to project a wire into the path of a vessel, to immobilise the vessel by fouling its propeller, as in a pirate attack.

In earlier International Patent Application No WO 99/30966 (hereinafter the “First International Application”), there was proposed:
An immobiliser device for a sea-faring vessel having a housing in which is stowed, in an unextended state, a length of fouling wire which, in use, is designed to foul the propeller and/or motor of a target vessel. The wire is automatically ejected from the housing on or soon after contact with the water. The wire may be ejected by being attached to a projectile that is propelled from the housing or may be wrapped around an inflatable member. The device allows a first vessel to take action to prevent the approach of a second threatening vessel or to immobilise a fleeing vessel.

It should be noted that as used herein the term “projectile” means the vehicle, typically launched from a compressed air launcher, which carries the vessel immobiliser from a ship under attack or other launch platform into the path of the vessel to be immobilised.

Difficulties have been experienced in deploying the inflatable member to extend the wire over a sufficient area of the sea and sufficiently quickly to form an effective deterrent.

To improve deployment of the inflatable member of a vessel immobiliser, and in particular to improve deployment of a plurality of such members at pre-determined orientations with respect to each other, by improving the directional stability of the inflatable member, in International Patent Application No WO 03/021180 (hereinafter the “Second International Application”) there is described and claimed a vessel immobiliser projectile having a casing and a vessel immobiliser carried in the casing, the vessel immobiliser comprising:
at least one inflatable member in the form of an inflatable roll,
means for inflating the inflatable member, and
propeller fouling members extending along and/or from the inflatable member,
   wherein:
the inflatable elongate member is a tube having one or more elongate stiffening members for providing the tube with directional stability on inflation.

It is envisaged that the inflatable member can be used for life saving.

### SUMMARY OF THE INVENTION

To further improve deployment and in accordance with the present invention, there is provided an inflatable member projectile comprising:
a projectile body having one end more buoyant than the other,
at least one vessel-immobilising, inflatable member in the form of an inflatable roll,
inflation means mounted in the body for inflating the inflatable member, the inflation mean including an inflation gas bottle at the less buoyant end of the body and
a cradle for supporting the or each roll in an orientation such that the inflatable member(s) unroll in a generally pre-determined deployment direction, i.e. with the projectile floating with the less buoyant end down corresponding with their orientation.

In the Second International Application, the rolls were arranged co-axially on top of each other, with their axes generally vertical. We found that such an arrangement did not necessarily start the rolls un-rolling in their intended direction, for instance at 120° to each other in the case of three inflatable tubes. However, with the cradle supporting the rolls in their deployment orientation with their axes generally horizontal, we have found that deployment is more reliable.

Preferably the cradle has an openable nose cone.

Conveniently, the cradle comprises a number of radiating channels, each locating one inflatable roll. Whilst each of the latter is actually rolled, it conveniently has a serpentine portion in the bottom of its channel, for assisting in lifting the roll over a closed end of the channel, a joint line between the cradle and the nose cone being at an even height along the channels and across the closed end. Alternatively, the ends of the channels can be open on deployment and closed by webs on the nose cone prior to deployment.

In accordance with a preferred feature of the invention, in addition to the serpentine ends of the rolls, the cradle has a lifter for lifting the rolls up out of the cradle. Conveniently the lifter is actuated by an actuator driven by the inflation gas. In the preferred embodiment, the body has a piston and cylinder actuator, having the piston attached to the lifter. The piston is hollow for communication of inflation gas through it to the inflatable rolls. Conveniently, fouling line such as high tensile wire or strap is accommodated in the hollow piston.

### BRIEF DESCRIPTION OF THE DRAWINGS

To help understanding of the invention, a specific embodiment thereof will now be described by way of example and with reference to the accompanying drawings, in which:

FIG. 1 is a sectional side view of a projectile according to the invention;

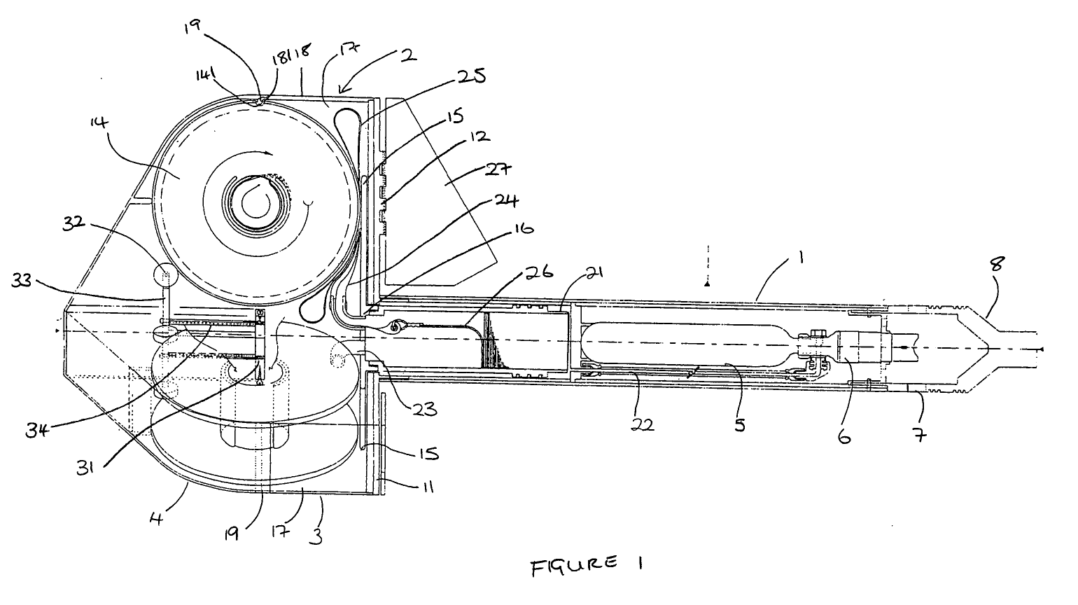

FIG. 2 is a plan view of the projectile of FIG. 1.

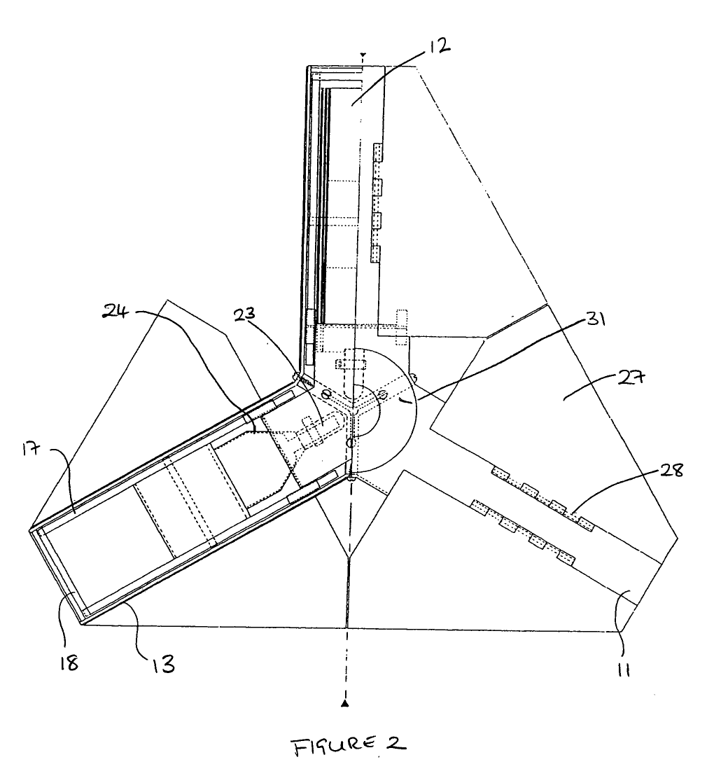

### DETAILED DESCRIPTION

Referring to the drawings, the projectile comprises a body 1 with a nose cone 2 comprised of a roll cradle 3 and a cap 4. The body houses an inflation gas bottle 5 with a release mechanism 6, to which water has access via openings 7. On launching of the projectile, the nose cone which has air filled voids floats, whilst the tail end 8 sinks, allowing water in and releasing gas, as described in more detail below.

The cradle 3 has three arms 11,12,13. The arms are channels, opening into each other centrally, where a three armed brace 31 holds the free edges of the channels together. Each channel supports a roll of inflatable tubing 14, equipped with stiffening and fouling elements, as described in the Second International Application. The rolls rest on the three fingers 15 of an ejector having a hub 16 and arranged in the channels beneath the brace 31. The cradle itself is fast with the body, having channel sides 17 and ends 18 retaining the rolls. The cap is of complementary shape to the cradle and clipped to it at a joint line 19.

The gas bottle is fixed into the body and discharges into a cylinder 21, via a pipe 22. A piston is slidably mounted in the cylinder. It is hollow and is in communication via ducts 23 in its head with end portions 24, laid in serpentine fashion 25, of the rolls. The head of the piston is screwed to the ejector 15,16. Fouling line 26, extending inside the rolls 14 is arranged in the piston.

On release of the gas, which occurs as the projectile floats cap up, the piston is forced up. The rolls are unable to inflate whilst held in the cradle by the cap. Thus the latter is forced off by the lifted rolls. The latter are restrained from leaving the channels directly in line with the action of piston and cylinder. Wheels 32, carried on a spider 33 fixed to the brace 31 via straps 34, bear on the rims of the rolls and give the rolls a radial motion. The rolls are induced to spin in their direction for unwinding their inflatable tubing, by engagement of notches 141 in their edges, with protrusions 181 in the ends 18 of the cradle.

Buoyant flaps 27 hinged 28 on the corners of the channels of the cradle float and deploy sideways. Thus they react sinking movement of the projectile when the rolls are being lifted from the body. Thus the rolls are lifted up and out over the joint line. The serpentine ends of the inflatable tube are now free to inflate and they push the rolls clear of the cradle. They are guided by the channels of the cradle to deploy radially of the body The inflatable tubes are thus thrown into the air at their intended angles of deployment. They unroll whilst still airborne to at least part of their extent. Finally unrolling to their full extent may occur across the surface of the sea—or other water.

The invention is not intended to be restricted to the details of the above-described embodiment. For instance the piston and cylinder actuator can be replaced by rolling diaphragm actuator. Again the cap retention clips at the joint line 19 can be replaced by a central rod extending in from the nose of the cap and engaging as by a spring detent with a second rod extending forwards from the piston 21.

The above-described embodiment is configured as a vessel immobiliser. However, it can be configured as a life buoy, with a line attached to it as it is launched, for retrieving a person from the water, who has grasped the device, by one of its inflatable members or one of the lines extending between the inflatable members.

What is claimed is:

1. An inflatable member projectile comprising:
a projectile body having one end more buoyant than the other,
at least one vessel-immobilising, inflatable member in the form of an inflatable roll,
inflation means mounted in the body for inflating the inflatable member, the inflation mean including an inflation gas bottle at the less buoyant end of the body, and
a cradle for supporting the or each roll in an orientation such that the inflatable member(s) unroll in a generally pre-determined deployment direction, i.e. with the projectile floating with the less buoyant end down corresponding with their orientation.

2. An inflatable member projectile as claimed in claim 1, wherein the cradle has an openable nose cone.

3. An inflatable member projectile as claimed in claim 2, wherein the cradle comprises a number of radiating channels, each locating one inflatable roll.

4. An inflatable member projectile as claimed in claim 3, wherein when each of the inflatable rolls is actually rolled, it has a serpentine portion in the bottom of its channel, for assisting in lifting the roll over a closed end of the channel, a joint line between the cradle and the nose cone being at an even height along the channels and across the closed end.

5. An inflatable member projectile as claimed in claim 3, wherein the ends of the channels are open on deployment and closed by webs on the nose cone prior to deployment.

6. An inflatable member projectile as claimed in claim 4, wherein the cradle has a lifter for lifting the rolls up out of the cradle.

7. An inflatable member projectile as claimed in claim 6, wherein the lifter is actuated by an actuator driven by the inflation gas.

8. An inflatable member projectile as claimed in claim 7, wherein the body has a piston and cylinder actuator, having the piston attached to the lifter.

9. An inflatable member projectile as claimed in claim 8, wherein the piston is hollow for communication of inflation gas through it to the inflatable rolls.

10. An inflatable member projectile as claimed in claim 9, wherein fouling line such as high tensile wire or strap is accommodated in the hollow piston.

11. An inflatable member projectile as claimed in claim 1, wherein the cradle comprises a number of radiating channels, each locating one inflatable roll.

12. An inflatable member projectile as claimed in claim 1, wherein the body has a piston and cylinder actuator, having the piston attached to the lifter.
